(19) United States
(12) Patent Application Publication
(10) Pub. No.: US 2008/0117061 A1
(43) Pub. Date: May 22, 2008

(54) Electroluminescent lighting for a managed-care setting

(75) Inventor: Karl Cazzini, Orchard Park, NY (US)

Correspondence Address: Kevin D. McCarthy;Roach Brown McCarthy & Gruber, P.C., 1620 Liberty Building, 420 Main Street, Buffalo, NY, 14202, US

(73) Assignee: Gaymar Industries, Inc.

(21) Appl. No.: 11/600,637

(22) Filed: Nov. 16, 2006

(51) Int. Cl. G08B 23/00

(52) U.S. Cl. 340/573.1

(57) ABSTRACT

A signaling system having a managed-care facility equipment and a light source are essential components of the present invention. The managed-care facility equipment measures a status of an individual. Based on the measurement of the individual's status in relation to a desired and/or expected measurement parameter, the equipment transmits a status signal that is at least either an alarm status signal or an acceptable status signal. The light source has at least a first flexible electroluminescent filament and receives the status signal. Depending on the status signal received, the light source alters the illumination of the first flexible electroluminescent filament.

### FIELD OF THE INVENTION

The present invention is directed to using an electroluminescent lighting device in a managed-care setting. The term managed-care setting includes and is not limited to any place where at least one individual is observed, monitored, cared for and/or supervised. Examples of such managed-care settings include and not limited to hospitals, prisons, nursing homes, elderly care settings, offices, child care centers or anything equivalent thereof.

### BACKGROUND OF THE INVENTION

There are numerous electroluminescent lighting devices. These devices are disclosed in the following U.S. patents, which are hereby incorporated by reference:

| U.S. Pat. No. | Title |
|---|---|
| 6,891,330 | Mechanically flexible organic |
| | electroluminescent device |
| | with directional light |
| | emission |
| 6,883,931 | Elongated illumination device |
| 6,869,202 | Lighting apparatus |
| 6,851,818 | Electroluminescent cable and |
| | mounting system therefor |
| 6,837,591 | Kitchen appliance with elongated |
| | light source |
| 6,817,731 | Elongated illumination device |
| 6,733,161 | Elongated carrier for bumper |
| | member |
| 6,686,064 | Electric luminescence fiber |
| 6,596,943 | Cables |
| 6,538,375 | Oled fiber light source |
| 6,400,093 | Flexible electro-luminescent light |
| | source with active protection |
| | from moisture |
| 6,074,071 | Aquarium lighting system |
| 6,011,352 | Flat fluorescent lamp |
| 5,869,930 | Electroluminescent light source |
| | with a mixture layer filled |
| | with a transparent filler |
| | substance |

Electroluminescent (“EL”) devices, which may be classified as either organic or inorganic, are well known in graphic display and imaging art. EL devices have been produced in different shapes for many applications. Inorganic EL devices, however, typically suffer from a required high activation voltage and low brightness. On the other hand, organic EL devices (“OELDs”), which have been developed more recently, offer the benefits of lower activation voltage and higher brightness in addition to simple manufacture, and, thus, the promise of more widespread applications.

An example, and not to be limited, of an electroluminescent lighting device has at least one flexible, cable-like electroluminescent filament. Each filament comprises a central electrode surrounded by an electrically insulating dielectric layer. A layer having a mixture of an electroluminophor powder and a binder is applied to the dielectric layer. A transparent electrode surrounds the mixture layer. Pores formed in the mixture layer are filled in by a transparent filler substance.

Another alternative flexible embodiment, and not to be limited to such, is an electroluminescent lighting device with a flexible metallic wire (normally copper) core coated with a phosphorescent like material. Two hair-thin wires, on top of a transparent-thin-metallic-layer, are wrapped around the core and a waterproof sheath is then applied before a colored translucent plastic layer encapsulates it all. When a high frequency electrical voltage is applied, it gives off a fluorescent glow, like neon.

ELAM EL Industries Ltd. asserts it has developed unique expertise in sputtering which allows the coating of wires in layers of thickness ranging from several angstroms to several microns. In the area of polymer creation, the company claims it has developed state-of-the-art binders and unique pigments, for ensuring the uniformity and durability of the wire coating, and creation of a variety of colors respectively. The polymer layers are highly hydrophobic, very adhesive, transparent, and possess desired dielectric characteristics.

Powered by battery-operated drivers or by a conventional industrial/household outlet, the electroluminescent lighting device wire emits light along its entire length as well as its circumference. These devices come in a wide variety of colors, and are cool to the touch. The flexible electroluminescent (EL) lighting wire is available in a wide range of diameters and can be cut to any length, from centimeters to hundreds of meters, as illustrated in Table 1.

TABLE 1

| Product | | | | |
|---|---|---|---|---|
| Type | Diameter | Power | Brightness | Colors |
| LyTec ® | 1.2 mm | 40 V/800 Hz | 1.8 cd/m² | lime, red, |
| Mini | | 80 V/4000 Hz | 68 cd/m² | purple, |
| | | | | pink, blue- |
| | | | | green, |
| | | | | green, |
| | | | | ultramarine, |
| | | | | and yellow |
| LyTec ® | 2.3 mm | 40 V/800 Hz | 1.8 cd/m² | white, blue- |
| General | | 80 V/4000 Hz | 68 cd/m² | green, |
| Purpose | | | | green, red, |
| | | | | pink, lime, |
| | | | | orange, |
| | | | | purple, hot |
| | | | | red, |
| | | | | ultramarine, |
| | | | | and yellow |
| LyTec ® | 2.5 mm | 40 V/800 Hz | 11 cd/m² | blue-green, |
| High | | 80 V/4000 Hz | 151 cd/m² | lime, red, |
| Bright | | | | pink, |
| | | | | ultramarine, |
| | | | | yellow, |
| | | | | purple, and |
| | | | | white |
| LyTec ® | 3.2 mm | 40 V/800 Hz | 1.8 cd/m² | white, blue- |
| Outdoors | | 80 V/4000 Hz | 68 cd/m² | green, |
| | | | | green, red, |
| | | | | pink, lime, |
| | | | | orange, |
| | | | | purple, |
| | | | | blood red, |
| | | | | ultramarine, |
| | | | | and yellow |
| LyTec ® | 3.2 mm to | 40 V/800 Hz | 1.8 cd/m² | blue-green, |
| Fabric | 9 mm | 80 V/4000 Hz | 68 cd/m² | pink, lime, |
| | | | | green, red, |
| | | | | and |
| | | | | ultramarine |
| LyTec ® | 2.8 mm to | 40 V/800 Hz | 1.8 cd/m² | green, blue- |
| Doublecore | 3.5 mm | 80 V/4000 Hz | 68 cd/m² | green, red, |
| | | | | lime, |
| | | | | ultramarine, |
| | | | | and yellow |
| LyTec ® | 5 mm | 40 V/800 Hz | 1.8 cd/m² | blue-green, |
| Thick | | 80 V/4000 Hz | 68 cd/m² | green, lime, |
| Diameter | | | | red, orange, |
| | | | | ultramarine, |
| | | | | yellow, and |
| | | | | white |

ELAM's flexible LyTec® light-emitting wires provide illumination to emergency teams, utility workers, outdoor enthusiasts and the general public by providing a continuous visual light source in limited visibility conditions. These wires have been incorporated into clothing, floors, stairs, backpacks, and numerous other items that are used to protect individuals from others and themselves.

LyTec® glowing, flexible, durable wires are easily integrated into all textiles and fabrics to provide clear and consistent visual communication in semi-dark and dark environments. Available in multiple diameters, lengths and brightness levels, the wires provide a reliable lighting delineation source for safety applications. Elam claims its LyTec wires never heat up and are completely safe for use with all kinds of fabrics.

Elam provides various module inverters for different desired electroluminescent lighting device wire lengths. The inverters can alter the lighting configuration from being continuous, blinking, on, off, and/or mixtures thereof. Moreover, the inverters can be designed for exterior and/or interior uses of electroluminescent lighting devices.

Elam also sells profiles for containing its electroluminescent lighting devices in particular settings and for particular uses. Elam has suggested using its electroluminescent lighting devices for marking stairways, escape routes, low level lighting systems and more. Elam asserts each profile's construction emphasizes the uniformity of the light, continuous or blinking and enhances the brightness. The profiles can be plastic or metallic. The profile can be of various shapes. Examples of the shapes are, and not limited to, omega (holds and protects the wire, dissipates its light and widens the angle of the light emission), combo (wide, rigid and decorative profile is designed for extensive durability, various stair-edge finishing [concrete, carpet etc.] and is equipped with anti-slipping rubber stripes), stair overlapping (screwed down to finished stair edge and is designed to prevent slipping), prism (for ceiling), and simple (to be inserted in a floor or any other surface).

As described above, electroluminescent lighting devices have been used in numerous applications. We have, however, been unable to find any disclosure of electroluminescent lighting devices that work in combination with equipment used in managed-care facilities.

The present invention solves that problem.

### SUMMARY OF THE INVENTION

A signaling system having a managed-care facility equipment and a light source are essential components of the present invention. The managed-care facility equipment measures a status of an individual. Based on the measurement of the individual's status in relation to a desired and/or expected measurement parameter, the equipment transmits a status signal that is at least either an alarm status signal or an acceptable status signal. The light source has at least a first flexible electroluminescent filament and receives the status signal. Depending on the status signal received, the light source alters the illumination of the first flexible electroluminescent filament.

### BRIEF DESCRIPTION OF THE FIGURES

FIG. 1 illustrates a schematic of the present invention.

FIG. 2 illustrates the prior use of a managed-care facility equipment.

FIG. 3a illustrates one possible embodiment of a comparator, and FIG. 3b illustrates another possible embodiment of the comparator.

### DETAILED DESCRIPTION OF THE PRESENT INVENTION

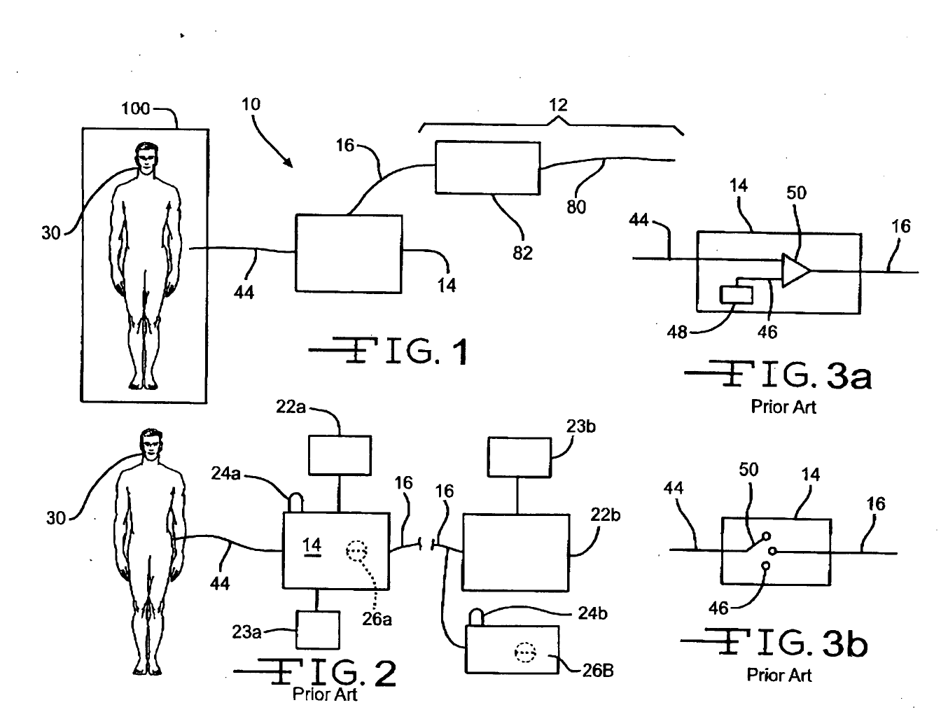

FIG. 1 illustrates a schematic embodiment of a signaling system 10. The signaling system 10 comprises an electroluminescent lighting device 12 and a managed-care facility equipment 14. Prior to addressing the present invention, the managed-care facility equipment 14 will be discussed in greater detail as to how the equipment is presently being used in today's environment.

In a managed-care facility, there is the observing entity and the observed mammal. For this application and for readability, we will refer the observing entity as a “nurse” and the observed mammal as a “patient.” Obviously, the description of a nurse and a patient are not to be limiting because the present invention has applications outside the scope of a hospital setting.

Presently the managed-care facility equipment 14 measures a desired status regarding the patient 30 as illustrated in FIG. 2. That measurement 44 could be any thing that relates to the patient 30.

The facility equipment 14 may be a wander alarm. A wander alarm measures if a patient moves from or on an object, like a bed 100, floor, and/or a chair. The wander alarm measures the weight applied to the object as disclosed in commonly-assigned U.S. Pat. No. 5,140,309. If the alarm determines the appropriate weight is not being applied to the object, the alarm generates and/or transmits a signal to get the nurse's attention.

The wander alarm can also measure the distance a patient is from the alarm as disclosed in Curbell's U.S. Pat. No. 5,933,083. In that reference, a rope having a predetermined length is attached to a patient and an alarm device. If the rope is disconnected from the alarm device, the alarm device generates and/or transmits an alarm to the nurse's attention.

Those wander alarm references and equivalents thereof are hereby incorporated by reference in this application.

Alternatively, the facility equipment 14 could measure a patient's vital signs. Examples of vital signs include and are not limited to a patient's cardiology issues, weight, pressure sore issues, pulmonary issues, neurological issues, weight (discussed for a wander alarm as well—able to be used in conjunction with pressure sore issues as well), external and/or internal patient temperature, temperature of fluids going into the patient, and gastrointestinal issues. The managed-care equipment 14 measures the vital sign data and then transmits the data to a print-out, a screen, and/or database for a nurse to review. In some vital sign monitoring equipment 14, the equipment is programmed to transmit an alarm signal to the nurse when a patient's vital signs are unacceptable.

The pressure sores can be managed by measuring and determining (a) the pressure within bladders used on a mattress and/or (b) the rotation of the patient on the mattress system. If the bladders are inflated to a desired pressure and/or the bladders rotate the patient properly, the patient should have a decreased chance of having pressure sores. Gaymar Industries, Inc. manufactures mattress systems that measure mattress inflation and deflation to obtain the desired pressure on patients to decrease the chance of pressure sores. Examples of such measuring devices are disclosed in commonly assigned U.S. Pat. No. 6,145,142 “Apparatus and Method for Controlling a Patient Positioned Upon a Cushion”; and commonly assigned allowed U.S. Pat. No. 6,943,694 “Bottoming Sensor.”

The external and internal temperature can be controlled through blankets, hand control devices, and/or overlays that have a medium of desired temperature run through the system. Examples of such devices are disclosed in commonly assigned U.S. Pat. No. 6,517,510 “Automatic Patient Control Device” and U.S. Pat. No. 6,149,674. As for fluid temperature control devices, an example of those devices are disclosed in commonly assigned U.S. Pat. No. 6,882,797 “Multiple Plate Fluid Warmer Unit.”

As illustrated, the facility equipment 14 measures a particular and desired patient's status or statuses. The applicants have set forth the obvious measurements that can be measured and monitored. Of course, there are other medical issues that can be monitored and controlled through other facility equipment.

In some facility equipment 14, the equipment has a comparator 50 or equivalent thereof as illustrated in FIGS. 3a and b. The comparator 50 compares the measurement 44 in relation to a desired and/or expected measurement parameter 46. The desired and/or expected measurement parameter 46 is transmitted by a programmable or fixed database 48, which could be within or outside of the facility equipment 14. The comparator 50 could be a switch as with the one wander alarm and as illustrated in FIG. 3b. In that embodiment, the measurement is a rope having (a) one end attached to the patient or clothing and (b) the other end connected to an object. The object applies pressure to the switch until the object is pulled away from the switch. The object remains in place on the switch until it overcomes the force from a resilient member—the desired measurement parameter.

The comparator could also be a conventional digital or analog comparator for weight, fluid temperature, or any of the patient's vital signs as illustrated in FIG. 3a. The measurement parameter 46 could be weight, pressure sore management (inflation of mattress), fluid temperature, distance, or any patient's vital signs that are programmed or fixed values.

If the measurement 44 is within the expected measurement parameter 46, the comparator 50 transmits a first signal (for example, an acceptable signal) 16a; and if the measurement 44 is outside the expected measurement parameter 46, the comparator 50 transmits a second signal (for example, an alarm signal) 16b. In any case, the comparator 50 transmits a status signal 16 (includes 16a and 16b collectively) to a screen monitor 22, a printer 23, a visual (normally non-flexible and a part of the facility measurement device 14) alarm 24, and/or an audio alarm 26. The status signal can be transmitted through a conventional electrical wire, a fiber optic conduit or any other conventional method to transmit an electrical, photonic, or optical signal from the facility measurement device 14 to the screen monitor 22a, 22b; the print out 23a, 23b; the visual alarm 24a, 24b; and the audio alarm 26a, 26b.

The screen monitor 22, the print out 23, the visual alarm 24, and/or the audio alarm 26 can be positioned (a) in the patient's room (numerals with the letter “a”) and/or (b) within a nurses' station area (numerals with the letter “b”). The visual alarm is a conventional light bulb or a LED device. Those conventional visual alarms cannot be incorporated into or on to floors, fabric materials, ceilings, or walls because there would be too many of them, they would break easily, and get too hot. The claimed light source does not create excessive heat and can be incorporated into or on to floors, fabric materials, ceilings, or walls to provide the desired subtle notice to the attendants for the patient being monitored.

The screen monitor 22, the printer 23, visual alarm 24 and audio alarm 26 can be (1) separate and distinct pieces of equipment, (2) combined in a single unit or (3) partially combined together. For example, the screen monitor and one of the alarms can be in a single unit or both alarms in a single unit. Alternatively, the devices could be components of the facility measurement device 14.

Devices 22, 23, 24, and/or 26 receive the status signal 16. If the status signal 16 is the alarm signal 16b, the visual alarm will activate, the audio alarm will activate, and/or the screen monitor, and printer will convey the alarm. These alarms are designed to notify the nurse at the nurses' station, in the hallways, and/or the nurse standing near the patient's bed side about the patient's status.

There are numerous problems with the prior art. One problem is that the patient could be positioned behind curtains like in a hospital or nursing home. An attendant may be unaware of a visual (including a screen monitor warning, and a print-out warning) or an audible alarm behind a curtain. Another problem is that a nurse may not be at the nurses' station area. The present invention attempts to solve that problem.

The present signaling system 10 solves that problem. The signaling system 10 comprises the electroluminescent lighting device 12 and the managed-care facility equipment 14. The electroluminescent lighting device 12 is interconnected to receive the signal 16.

The electroluminescent lighting device 12 comprises the illuminating wires 80 and the inverter 82. The illuminating wires 80 should have constant illumination, with little to no attenuation over the length of the wire. The electroluminescent lighting device 12 could and should be cheaper and simpler than LED technology, have lower power consumption, and little to no heat build-up. Obviously, the intensity of the illuminating wires 80 may vary by controlling the supply frequency.

The electroluminescent lighting device 12 receives the signals 16 and alters its illumination of the wires 80 depending on the signal 16 received. Examples of how the electroluminescent lighting device may operate in relation to each particular signal 16a, 16b are described, and not limited to, in Table 2.

TABLE 2

| | Number of | Alarm Signal | Acceptable |
|---|---|---|---|
| Example | Wires | 16b | Signal 16a |
| 1 | One | Blinking | Continuous |
| 2 | One | On | Off |
| 3 | One | Continuous | Blinking |
| 4 | Two wires | Continuous or | Opposite for |
| | having the | blinking for | second wire |
| | same color | first wire | |
| 5 | At least Two | First Color | Second Color |
| | wires having | wire operates | wire operates |
| | different | and second wire | and first wire |
| | colors | does not; | does not; |
| | | blinking or | blinking or |
| | | continuous | continuous |

Table 2 provides a guideline of what the illuminating wires can do when receiving the alarm (a.k.a., second) signal or the acceptable (a.k.a., first) signal. If there are more wires, the options of what the illuminating wires can do increase. If the managed-care facility equipment 14 has more signals, the options increase as well.

The present illuminating wires 80 can be positioned within the floor, wall, and/or ceiling of the patient's room and/or within a drapery or a hospital patient curtain that can surround the patient 30. The location of the illuminating wires 80 is not novel as a means to assist individuals find their way through the dark, since that was disclosed by Elam. What is novel is the interaction of the electroluminescent lighting device 12 in response to the status signal 16 from the managed-care facility equipment 14.

That interaction provides further monitoring, observation assistance to the caregiver (nurse) as to the occurrence of at least a particular patient's status. Simultaneously, the interaction can provide the patient 30 with guidance during the night time, if needed, to the bathroom and/or any other direction that may be sought by a patient.

The signaling system 10 would also provide minimum interruption to the patient since the electroluminescent lighting device 12 does not have to be adjacent to the patient 30 as the audio and visual alarms normally are that are positioned within the patient's room. Hence the present invention does not interrupt the patient's sleep like the prior art embodiments. The present invention operates without interfering with the patient.

The present invention can be incorporated with the prior art methods of notifying the caregiver (nurse) about the patient's status regarding position, location, and vital signs which includes weight, gastrointestinal issues, cardiology issues, pulmonary issues, neurological issues, and temperature.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

We claim:

1. A patient signaling system comprising
a managed-care facility equipment that measures a status of a patient and based on the measurement of the patient's status in relation to a desired and/or expected measurement parameter transmits a status signal that is at least either an alarm status signal or an acceptable status signal;
a light source (a) having at least a first flexible electroluminescent filament, (b) receives the status signal, (c) alters the illuminatation of the first flexible electroluminescent filament based on the received status signal to provide an illumination signal to a patient monitor about the measured status of the patient, and (d) is (i) embedded within or on a fabric material near the patient (ii) embedded in and/or attached to a floor near the patient, (iii) embedded in and/or attached to a wall near the patient, (iv) embedded in and/or attached to a ceiling near the patient or (v) combinations thereof.

2. The signaling system of claim 1 wherein each filament comprises:
a central electrode surrounded by an electrically insulating dielectric layer;
a layer consisting of a mixture of an electroluminophor powder and a binder, said mixture layer being disposed on said dielectric layer;
a transparent electrode surrounding said mixture layer,
wherein pores formed in said mixture layer are filled in by a liquid solid transparent filler substance.

3. The signaling system of claim 1 wherein the managed-care facility equipment measures the individual's vital signs, and/or distance from the managed-care facility equipment.

4. The signaling system of claim 3 wherein the vital signs are the individual's cardiology issues, the individual's pulmonary issues, the individual's neurological issues, the inflation and/or rotation to decrease the chance of an individual skin having pressure sores, the individual's internal and/or external temperature, the individual's weight, the fluid temperature the enters the individual, and/or the individual's gastrointestinal issues.

5. The signaling system of claim 1 wherein the alarm status signal is transmitted when the measurement of the individual's status is outside the desired and/or expected measurement parameter.

6. The signaling system of claim 1 wherein the acceptable status signal is transmitted when the measurement of the individual's status is within the desired and/or expected measurement parameter.

7. The signaling system of claim 1 wherein the first flexible electroluminescent filament is turned on when the alarm signal is received.

8. The signaling system of claim 1 wherein the first flexible electroluminescent filament is turned off when the alarm signal is received.

9. The signaling system of claim 1 wherein the first flexible electroluminescent filament initiates a blinking illumination when the alarm signal is received.

10. The signaling system of claim 1 wherein the first flexible electroluminescent filament initiates a continuous illumination when the alarm signal is received.

11. The signaling system of claim 1 wherein the light source further comprises at least a second flexible electroluminescent filament.

12. The signaling system of claim 11 wherein the first flexible electroluminescent filament illuminates a first color and the second flexible electroluminescent filament illuminates a second color different from the first color.

13. The signaling system of claim 11 wherein the second first flexible electroluminescent filament illuminates when the light source receives the alarm status signal, and the first flexible electroluminescent filament illuminates when the light source receives the acceptable alarm status signal.

14. The signaling system of claim 13 wherein the illumination for the first flexible electroluminescent filament and the second flexible electroluminescent filament are selected from the group consisting of on, off, blinking, continuous and combinations thereof.

15. The signaling system of claim 14 wherein the first flexible electroluminescent filament and the second flexible electroluminescent filament are different colors.

16. The signaling system of claim 1 wherein the fabric material is a blanket positioned on or near the patient.

17. The signaling system of claim 1 wherein the fabric material is a hospital patient curtain that can surround the patient.

18. A method of using a patient signaling system comprising:
measuring a status of a patient with a managed-care facility equipment;
comparing the measurement of the individual's status in relation to a desired and/or expected measurement parameter;
transmitting a status signal that is at least either an alarm status signal or an acceptable status signal to a light source having at least a first flexible electroluminescent filament positioned within and/or on a fabric material near the patient and to alter the illuminatation of the first flexible electroluminescent filament based on the received status signal.

19. A process of signaling medical assistants about the status of a patient comprising:
a managed-care facility equipment that measures a status of a patient and based on the measurement of the patient's status in relation to a desired and/or expected measurement parameter transmits a status signal that is at least either an alarm status signal or an acceptable status signal;
a light source (a) having at least a first flexible electroluminescent filament, (b) receives the status signal, (c) alters the illuminatation of the first flexible electroluminescent filament based on the received status signal to provide an illumination signal to a patient monitor about the measured status of the patient, and (d) is (i) embedded within or on a fabric material near the patient (ii) embedded in and/or attached to a floor near the patient, (iii) embedded in and/or attached to a wall near the patient, (iv) embedded in and/or attached to a ceiling near the patient or (v) combinations thereof.
